(19) United States
(12) Patent Application Publication
(10) Pub. No.: US 2002/0161691 A1
(43) Pub. Date: Oct. 31, 2002

(54) Real-time internet auction system

(76) Inventor: Junichiro Nishi, Kobe (JP)

Correspondence Address: KLEIN, O'NEILL & SINGH, 2 PARK PLAZA, SUITE 510, IRVINE, CA, 92614, US

(21) Appl. No.: 09/809,583

(22) Filed: Mar. 15, 2001

(30) Foreign Application Priority Data
Mar. 15, 2000 (JP) 2000-072260

(51) Int. Cl. G06F 17/60; G06F 15/16

(52) U.S. Cl. 705/37; 705/26; 705/39; 709/203

(57) ABSTRACT

A real-time auction system that is the same as traditional auctions by utilizing the internet. The system utilizes computers in which a number of buyers bid a price for a product and the bids are transmitted over the internet to a computer for an organizer, an assessor, a center and each buyer. If there is more than one bid over a reserve price set by the assessor the process repeats until at only one bid is left. The one bid left is the successful bidder. When there are no bids above the reserve price set, the process repeats a predetermined number of times.

### DEFINITION OF THE INVENTION

[Item 1]

A real-time auction system with the features below;

The auction system consists of four computers:

The computer 1 operated by the auction organizer.

The computer 2 operated by the assessor, who exhibits and assesses products.

The computer 3 operated by the buyer, who buys products.

The computer 4 performs the center processing.

Data are sent and received through the Internet by those computers.

The auction is operated by the following process:

(Step 1) The buyer bids (a price) (Time period 1). The bid information is transmitted to the computer 1.

(Step 2) Bidding status is transmitted to computer 1, computer 2 and computer 3.

(Step 3) The organizer, the assessor, and the buyer confirm the bidding status. (Time period 2)

(Step 4) If there is more than one bid above the reserve price submitted by the assessor, the process repeats from step 1. The process repeats until there is only one bid left. Then the last remaining bidder is the successful bidder.

Even though there is no bid above the reserve price submitted by the assessor, the process repeats from step 1. However, the process will not repeat more than the preset number of times.

[Item 2]

A real-time auction system defined in item 1 with the functions below:

The screen of computer 2 has a time indicator, bid-price indicator, and bid button.

In Step 1, the price on the bid-price indicator rises from the floor price to the ceiling price at a fixed speed. The time indicator rises at the same time and keeps pace with the bid-price indicator. The buyer can click on the bid button when bid-price indicator reaches the price the buyer wants to bid.

[Item 3]

A real-time auction system defined in item 1 and item 2 with the functions below:

The buyer can bid before the auction opens. After the auction opens, these pre-entered bids, which are entered by each buyer while the auction is open, are treated as the maximum bid prices.

[Item 4]

A real-time auction system defined in item 1 through item 3 with the functions below:

When no bid is above the reserve price proposed by the assessor in (step 3), the assessor can designate the buyer who bid the highest price as the successful bidder on the computer 2.

[Item 5]

A real-time auction system defined in item 1 through item 4 with the functions below:

The first bidder who enters a price that is above the reserve price can see an indication that tells that he (she) was the first bidder who entered a price that was above the reserve price.

[Item 6]

Electromagnetic recording mediums that store computer programs used by computer 1, computer 2, computer 3 and computer 4 in the auction system defined in item 1 through item 5.

### DETAILS OF THE INVENTION

[The field of technology]

This invention is for an Internet-based auction system and an auction system that enable all participants real-time functionality as they have in traditional live auctions.

[Conventional Technology]

There are auction systems developed and in use, where auction buyers connect to computer systems that auction organizers operate for auctions via various means of communication and carry out auctions.

Provisional Publication No. 11-328,271 defines an auction system where buyers can participate in the auctions with terminal equipments such as a personal computer without going to auction hall. Moreover, remote-buyers can participate in more than one auction optionally since communication control units (which is a part of a communication circuit) send and receive auction data to/from more than one auction halls.

Usually, a conventional remote auction system, which consists of communication lines, main computers and personal computers, sets bid terms from an hour to several days. Within these bid terms, remote buyers enter their bidding prices via equipments such as personal computers. The successful bidder is the one who enters the highest bidding price within the bid term.

The following general problems are pointed out in the auction systems mentioned above.

1) Most bidders bid in the last minutes. These bidders tend to observe the situation at the beginning and bid the price based on the observation just before the auction closes. In this case, it is important to bid as late as possible. This situation does not happen in non-remote (traditional) auctions.

2) In most cases, sellers cannot change their reserve prices that they set in advance. When bidding prices are much higher than the reserve price, sellers can lose opportunities to sell items at higher prices.

[Problems That the Invention Tries to Solve]

Therefore, the invention aims at enabling all the participants including an assessor, a seller, and an organizer to conduct auctions with real-time nature on the Internet just as they do in traditional auctions.

[Solution to the Problems]

This invention was invented to solve the problem described above.

The real-time auction system described in item 1 has the features below:

The auction system consists of four computers:

The computer 1 operated by the auction organizer.

The computer 2 operated by the assessor, who exhibits and assesses products.

The computer 3 operated by the buyer, who buys products.

The computer 4 performs the center processing.

These computers send and receive data through the Internet.

The auction is operated by the following processes:

(Step 1) The buyer bids (a price) (Time period 1). The bid information is transmitted to computer 1.

(Step 2) Bidding status is transmitted to computer 1, computer 2 and computer 3.

(Step 3) The organizer, the assessor, and the buyer confirm the bidding status. (Time period 2)

(Step 4) If there is more than one bid above the price proposed by the assessor, the process repeats from step 1. The process repeats until there is only one bid left. Then the bidder left is the successful bidder.

Even though there is no bid above the reserve price entered by the assessor, the process repeats from step 1. However, the process does not repeat more than the preset number of times.

The real-time auction system described in item 2 is an auction system defined in item 1 with the functions below:

The screen of computer 2 has a time indicator, bid-price indicator, and bid buttons.

In Step 1, the price on the bid-price indicator rises from the floor price to the ceiling price at a fixed speed. The time indicator rises at the same time and keeps pace with the bid-price indicator. The buyer can click on the bid button when bid-price indicator reaches the price the buyer wants to bid.

The real-time auction system described in item 3 is a real-time auction system defined in item 1 and item 2 with the functions below:

The buyer can bid before the auction starts. After the auction starts, these pre-entered bids, which are entered by each buyer while the auction is open, are treated as the maximum bid prices.

The real-time auction system described in item 4 is a real-time auction system defined in item 1 through item 3 with the functions below:

When no bid is higher than the reserve price entered by the assessor in (step 3), the assessor can designate the buyer who bid the highest price as the successful bidder on computer 2.

The real-time auction system described in item 5 is a real-time auction system defined in item 1 through item 4 with the functions below:

The first bidder who enters a price that is above the reserve price can see an indication that tells that he (she) was the first bidder who entered a price that was above the reserve price.

Electromagnetic recording mediums, described in item 6, store computer programs used by computer 1, computer 2, computer 3 and computer 4 in the auction system defined in item 1 through item 5.

[Forms of an Implementation of the Invention]

The followings describe the forms of the implementation (refer to the figure below).

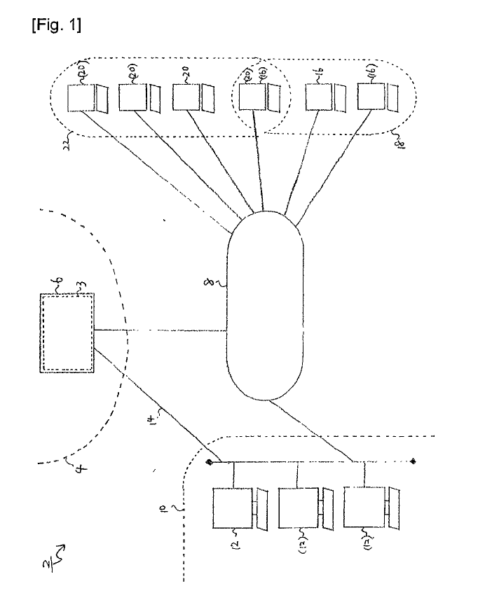

FIG. 1 shows the system structure of the Internet auction system 2 in this invention.

The auction center equipment 6 is placed in the auction center 4, which run the main system, and the center system 4. The auction center equipment 6 is connected to the Internet 8. The computer 12 operated by the organizer (the organizer equipment) is placed in the organizer office 10. However, the structure does not need to be limited to the one shown in the figure. For instance, the organizer equipment 12 can be stand-alone. The organizer equipment is connected to the Internet 8. The organizer equipment 12 is connected to the auction center equipment 6 via the independent communication line 14 (that does not pass the Internet 8) for certain tasks.

The assessors communicate the auction data to the auction center equipment 6 and the organizer equipment 12 via the Internet by using their equipments 16 such as personal computers (the assessor equipment). Assessors can have auction sellers (this is not shown in the figure). Auction sellers communicate to their assessors with means such as phone and the Internet. Information of sellers needs to be provided at the assessor equipments 16. The number of auction assessors is usually more than one (The assessors 18).

Buyers' auction data are exchanged with the auction center equipment 6 and the organizer equipment 12 via the Internet by using their equipments 20 such as personal computers (the buyer equipment). The buyers' equipment 20 and the assessors' equipment 16 are connected to the Internet 8 and the auction center equipment 6. Data submitted at the buyer equipment 20 is sent to and shown on the assessor equipment 16. Data submitted at the assessor equipment 16 is sent to and shown on the buyer equipment 20. Data is transmitted and processed in the same way between the organizer equipment 12 and the assessor equipment 16, and between the organizer equipment 12 and the buyer equipment 20. Usually the number of buyers is more than one (the buyers 22) and buyers can be assessors.

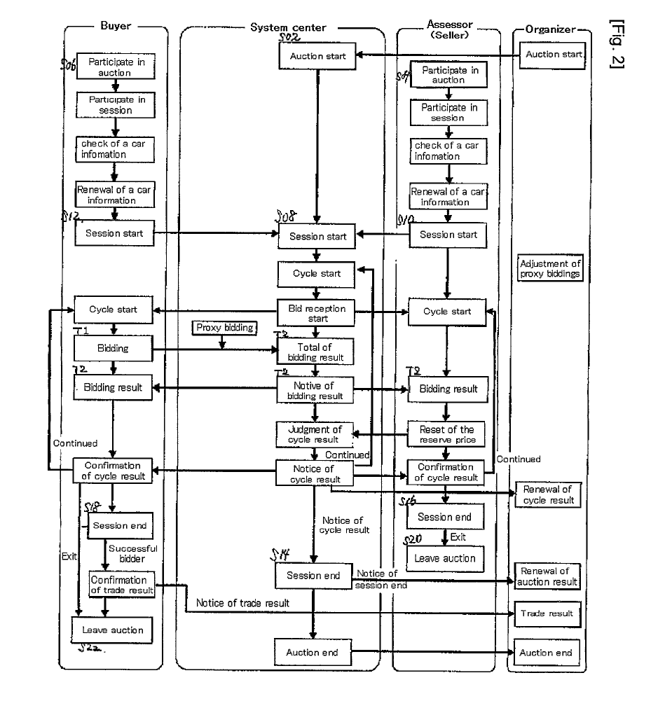

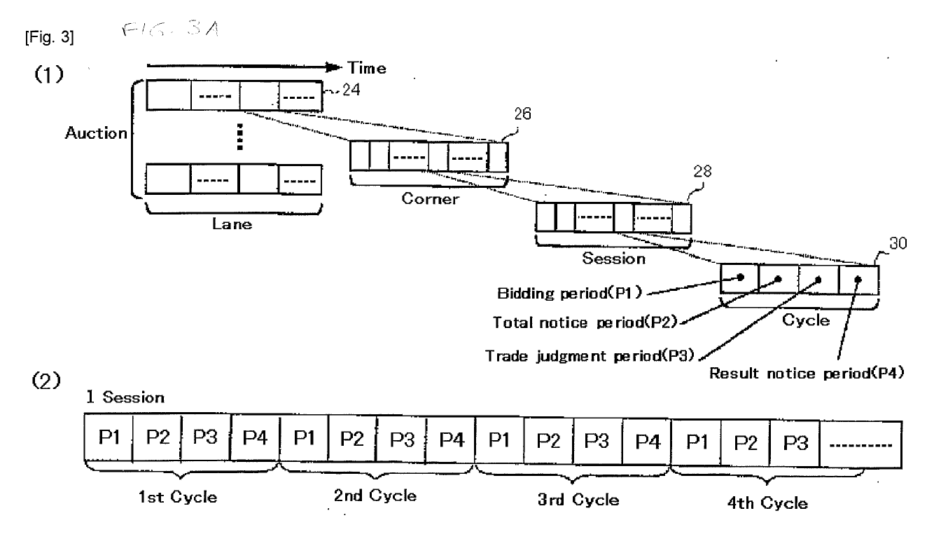

FIG. 2 indicates the workflow of the Internet auction system in this invention. FIG. 3 indicates system-processing flow in this Internet auction system. FIG. 3 shows the auction system, which consists of more than one lane 24. Auction activities can be processed in parallel since there is more than one lane 24. This means that one buyer (or one assessor) can participate in more than one auction with one buyer equipment 20 (or one assessor equipment 16).

Each lane 24 of FIG. 3 is divided into corner 26 by the product category. A collection of corner 26 constitutes a line 24. Each corner 26 is constituted by more than one session 28. In one session 28 one good is put up for auction where it is successfully bid on or it is aborted. Each session 28 consists of one or more cycles 30, and a cycle 30 is divided into four periods (the bidding period P1, the bidding status notification period P2, the trade judgment period P3, and the dealing result notification period P4). A later section explains the relationship between session 28 and its component, cycle 30, and the relationship between cycle 30 and its components, the four periods.

The lengths of the four periods mentioned above are configurable at the organizer equipment. In this invention, the Internet auction system 2 is assumed to take several seconds or more. Therefore, the time length of one cycle will take several seconds or more, and the time length of one session will be from several seconds to several minutes.

FIG. 2 explains the system flow of the Internet auction system 2. Buyers, assessors, and sellers can see information on goods that will be put up for an auction in terms of auctions via the Internet 8, since this information are open to the public at the center system 3 (This is not indicated in the figure.).

First, an organizer starts an auction (Step S02). Participants participate in the auction with the assessor equipment 16 and the buyer equipment 20 (Step S04 and S06). The center system 3 starts a session after participants sign up for the session (Step S08). At the same time, participants join the session at the assessor equipment 16 and the buyer equipment 20 (Step S10 and S12).

In the center system 3, the 1st cycle starts when a session starts. In one cycle, bidding, collection of bidding data and notification of dealing results are taken place. The session repeats until the goods are successfully bid on or the dealings are aborted. At the buyer equipment 20, buyers enter bids, referring to the dealing results from the center system 3. Assessors can control an auction with “reserve price modification” in real-time (it is explained later.).

After the session finished (Step S14, S16, and S18), buyers and organizers leave the auction (Step S20 and S22). Otherwise, they can stay and continue with the next session.

When an auction (including all of its tasks) in the center system 2 is completed, it is notified to the organizer equipment 12.

An organizer can cancel an awaiting session before that session start and when that session is under way. This enables an organizer to interrupt auctions for unpredictable reasons.

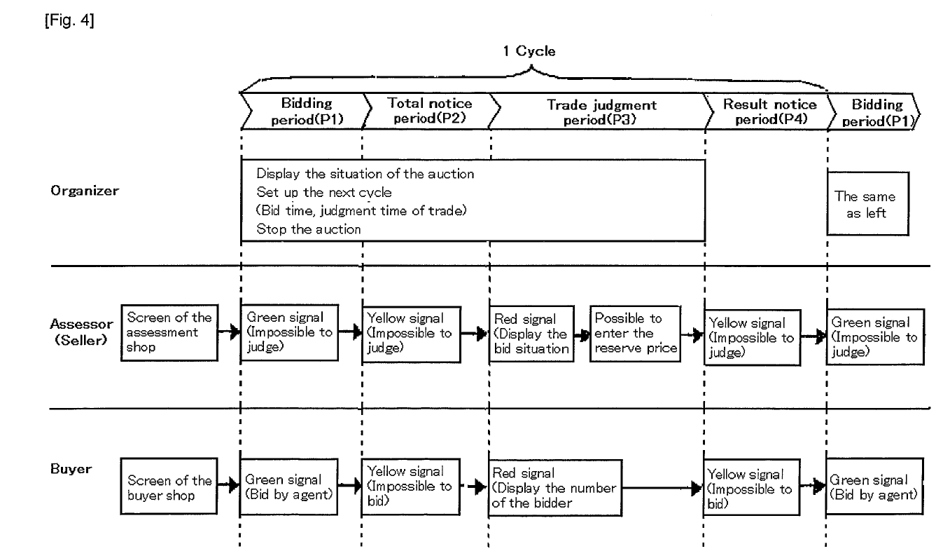

FIG. 4 shows a detail flow of the cycle 30. As FIG. 4 shows, one cycle consists of four continuous periods:

Bidding period P1

Bidding status notification period P2

Trade judgment period P3

Dealing result notice period P4

As shown in FIG. 4, the assessor screen and the buyer screen are displayed in the assessor equipment 16 and the buyer equipment 20. A cycle starts and the “bidding period begins first, buyers can enter bids from the buyer equipment 20 (refer to FIG. 2; T1). At this time, there is no input operation of the data from the assessor equipment 16.

Next, in the “bidding status notification period P2,” the center system 3 collects entered bids and the bidding status is then displayed on the assessors' equipment 16 and the buyers' equipment 20 screens (refer to FIG. 2; T2).

In the “trade judgment period P3,” referring to the result of “bidding status notification period P2,” the assessor can execute “reserve price modification” and send a request to sell the goods with the highest price entered by buyers at that cycle. This means, when certain conditions are satisfied, assessors (or sellers) can show their decision to sell goods, by looking at the status of the auction on the screen. “Reserve price modification” is explained in a later section.

In the “dealing result notification period P4,” the system shows the result of the “bidding status notification period P2” and the “trade judgment period P3,” and the session status below:

Whether the goods were successfully bid on or the auction was abortive.

Whether the auction continues (and starts the next cycle)

If dealings continue, the next “bidding period P1” begins.

Organizers are in charge of surveillance and management of auctions while cycles are operated (shown in FIG. 4). Organizers perform the operation below:

Provide status information of auctions

Decide conditions (such as length of bidding period and length of dealing judgment period)

Suspend auctions when it is necessary.

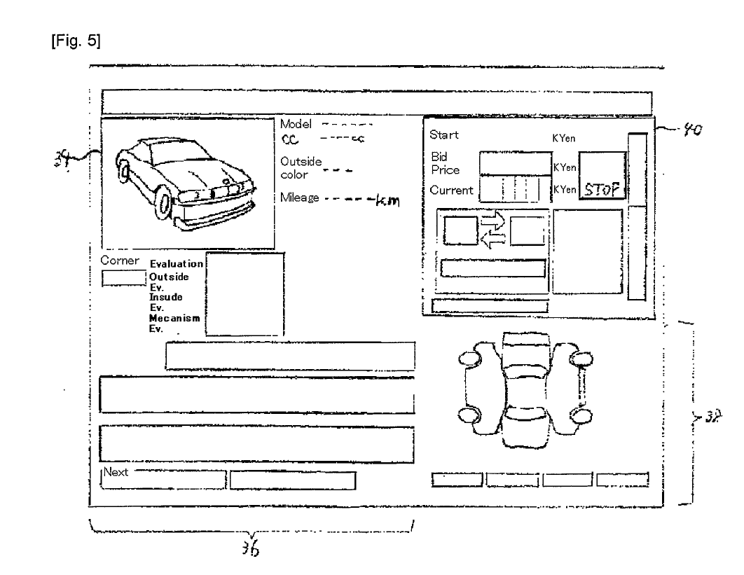

FIG. 5 is an example of the screen on the organizer equipment 12, the assessor equipment 16 and the buyer equipment 20 in the “bidding period P1.” The left side of FIG. 5 is the information field 36, including screen 34. The lower right part of the screen is the information field 38. The upper right part of the screen is input area 40. First, buyers can enter their bid on the input area 40. Second, the assessor equipment and the buyer equipment 20 show the status of the bidding. Then the “reserve price modification” is requested and the session status is shown on the assessor equipment.

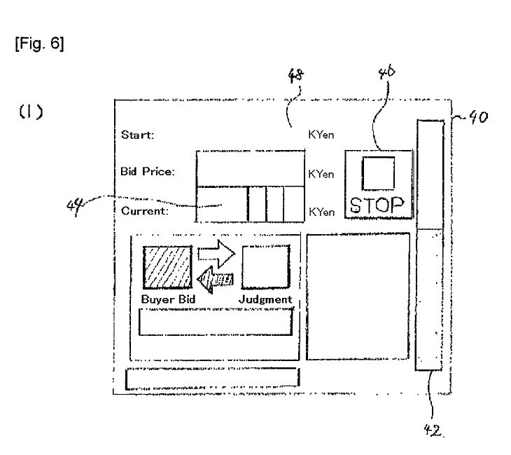

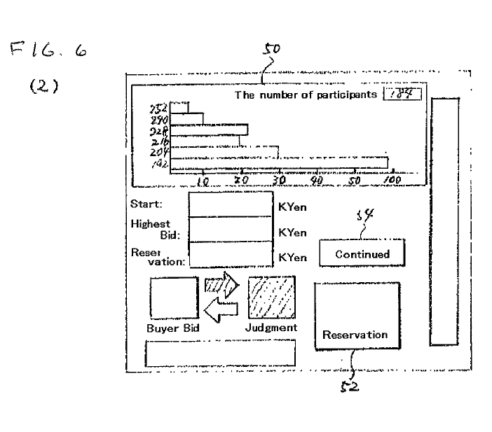

FIG. 6 (1) shows the input area 40 in FIG. 5 of the organizer equipment 12, the assessor equipment 16 and the buyer equipment 20 in the “bidding period P1.” Assessors set “ceiling price” for each cycle in advance. “Assessors (or sellers) can set starting prices 48 before the auction starts. If this is not the first cycle, then the highest price (that the buyers entered) in the last cycle is the starting price.

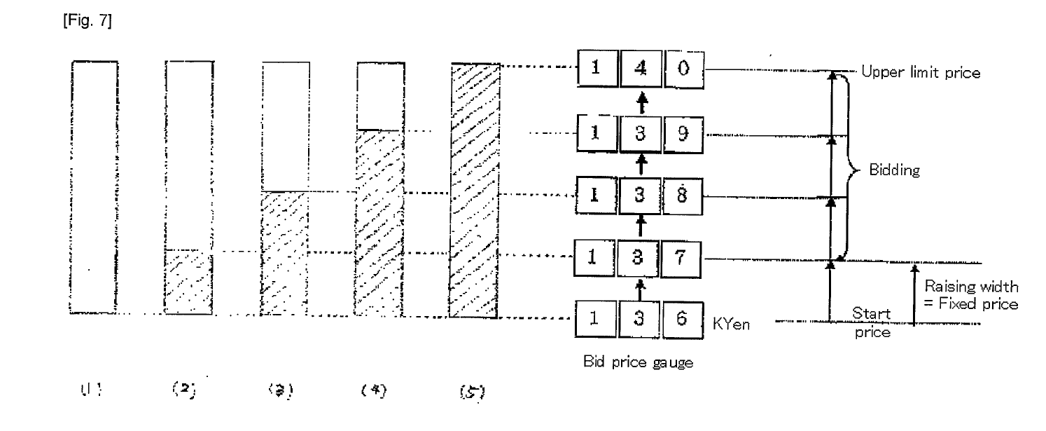

The time indicator 42 is shown in FIG. 6 (1). The time indicator 42 has a colored stick graph that goes up from the bottom to the top as the time elapses (refer to FIG. 7 (1), (2), (3), (4), and (5).). As already described in the previous section, the organizer sets the length of time it takes for the stick graph to reach the top of the gauge from the bottom (the length of the bidding period) of the organizer equipment 12. At the same time, the price on the bidding price indicator 44 rises from “the starting price” to “the ceiling price” and keeps pace with the time indicator 42. FIG. 7 shows progress of the time indicator 42 and the bidding price indicator 44. The example in FIG. 7, “starting price” is “1,360,000 yen” and “ceiling price” is “1,400,000 yen.”

Buyers can enter their bidding prices by observing the time indicator 42 and the bidding price indicator 44. Buyers click the buyers' bid button 46 on the input area 40, now the price indicator points to the price they want to bid. The entered data is sent to the center system 3 via the Internet 8. Buyers can click on the bid button only after the bidding price indicator points to the next value of the starting price (in the case of FIG. 7, it is 137,000). In addition, buyers can enter bids as many as they want at the buyer equipment 20 in the same cycle. In this case, the last entry of the bid is valid and earlier bids are ignored.

FIG. 6 (2) shows the input area 40 on FIG. 5 of both of the organizer equipment 12 and the assessor equipment 16 during the “bidding status notification period P2” and the “trade judgment period P3.” The chart 50 shows the relationship between the bidding prices and the number of bid entries. The assessor and sellers can click on the “reserve price modification button” or “Continue (cycle) button” on the input area 40 (refer to the chart 50).

The following information is provided by the center system 3 and is shown on all the terminal equipments in the “dealing result notification period P4”:

Whether the goods were successfully bid on or the auction was abortive.

Whether the auction continues (and goes on to the next cycle) or not.

If the auction continues, the following information is shown

The result of the last cycle

The condition of the next cycle (such as starting price, ceiling price)

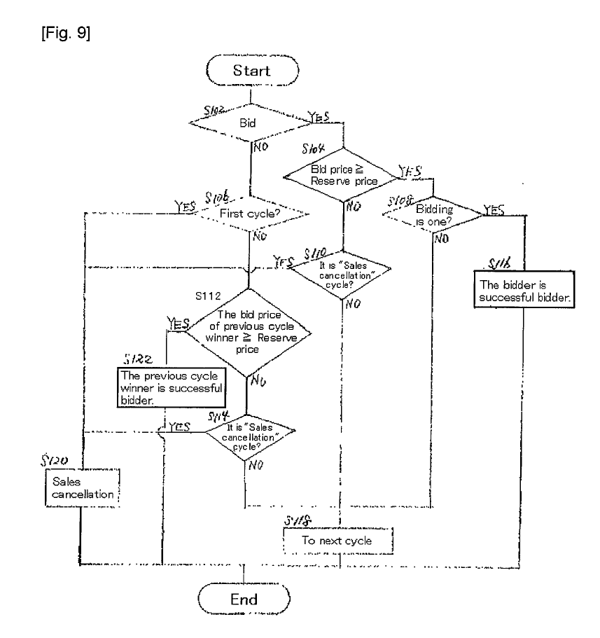

FIG. 9 is the judgment flow in the center system 3 in the “dealing result notification period P4”:

Whether the goods were successfully bid on or the auction was abortive.

Whether the auction continues (and goes onto the next cycle).

This flow chart is designed on the assumption that no “reserve price modification” is executed on the assessor equipment 16 in the “trade judgment P3.” The “reserve price modification” is explained in detail later.

FIG. 9—Step S102:

Check whether there has been any bid entry in this cycle. If there has been, it goes to S104, if not, it goes to S106.

Step S104:

Check whether the highest price in all the bidding prices is more than the “reserve price.” If it is over the reserve price and only one buyer enters that cycle (Step S108), then that single buyer is the successful bidder and the auction (session) is closed. If there is more than one buyer who enters a bid above the “reserve price,” the next cycle starts (Step S118) since higher bidding price can be entered.

At Step S104, if there is no bid over the “reserve price,” the system needs to judge if this cycle reached the “maximum number of cycles” (Step S110). No bid can be successful over several cycles when the reserve price is too high. The organizer can set the “maximum number of cycles” to avoid repeating sessions that are difficult to be successful. For instance, if the “maximum number of cycles” is set to “4,” Step 110 checks whether the current cycle is the 4^{th} one or not. If the current cycle reached “maximum number of cycles,” the auction is aborted and the session is terminated (Step 120). If not, the next cycle starts (Step 118).

Step S106:

The steps after this step will be processed if there is no bid entry at the current cycle. Step 106 check if the current cycle is the first one or not. If it is the first cycle, it is considered that there is no buyer willing to buy the goods and the cycle and auction is closed (S120). If not, the process goes to Step 112.

Step S112:

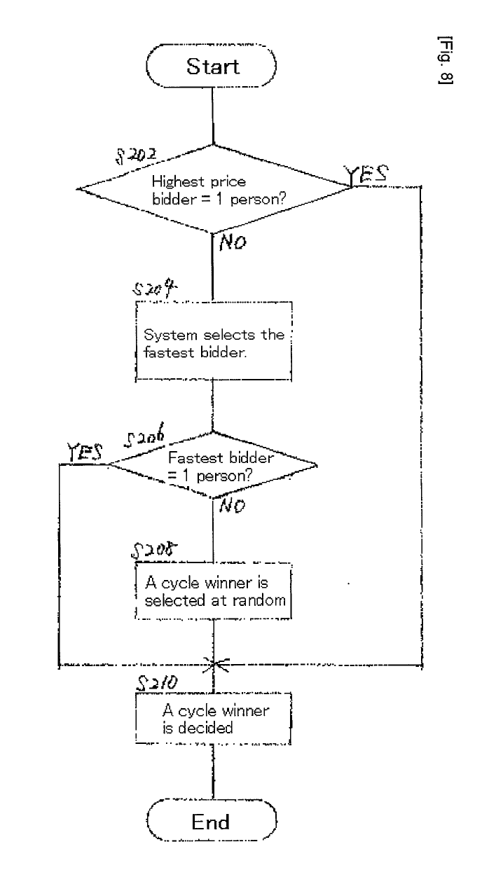

Confirms if the cycle winner (refer to FIG. 8) of the last cycle bided a higher price than the reserve price. The “cycle winner” is the buyer who enters the highest bid in a cycle. The details are explained with FIG. 8 later.

At the step S112, if “the bidding price of the cycle winner was over the reserve price in the last cycle,” this means that the last cycle winner successfully bid and the cycle and the auction is closed (Step S122). If not, the process goes to Step S114.

At step S114, the system confirms if the current cycle is the “maximum number of cycles.” If the judgment is yes, the cycle and the auction are aborted (Step S120). If the judgment is no, the process goes onto the next cycle. (Step S118).

After these processes, the flow chart in the FIG. 9 ends.

As described above, FIG. 8 shows a flow of the determination logic of a “cycle winner.”

Step S202:

Confirms if there is more than one buyer who enters the highest bidding price. If there is only one, it goes to Step S210. If more than one, it goes to Step S204.

Step S204:

Specifies the buyer who entered the highest bidding price earliest when there is more than one buyer who enters the highest bidding price. If it is a “representation bidding,” the timing when a buyer enters is considered when he (she) enters a “representation bidding.”

Step S206:

Confirms if there is only one buyer who entered the highest bidding price the earliest. If only one, it goes to Step S210. If more than one, it goes to Step S208.

Step S208:

Picks one buyer randomly from buyers who entered the highest bidding price at the earliest timing.

Step S210:

The only one bidder left is the cycle winner.

Participants can see the information on the cycle winner, the ranking chart and the summary data on the organizer equipment 12, assessor equipment 16 and buyer equipment 20. Therefore, the cycle winner can decide on the next bidding, by referring to that information.

Optionally, the system can provide the feature that the buyer, who entered a price that is higher than the reserve price and the highest at the earliest time, can see the “you have the right” notification on his (her) input area 40 on the buyer equipment 40.

<<Other implementation of bid entry>>

In the description above, a bidding price is entered at the buyer equipment 20, which is connected to the center system 3 through the Internet 8 in real-time. This implementation allows buyers to bid before the session starts if the bid satisfies certain conditions. This implementation assumes that it is known that buyers cannot access the Internet auction system 2 for some reasons. We call this bid entry “representation bidding.”

A representation bidding is entered at the buyer equipment and transmitted to the center system 3 and the organizer equipment 12. The “representation bidding” has information on the identification of the buyer, entry date and time, goods, and ceiling price.

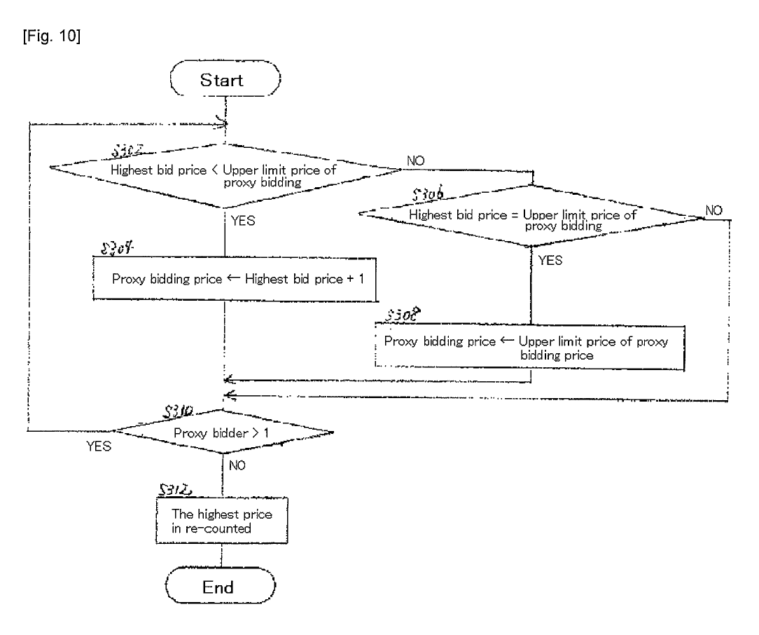

FIG. 10 is an example of a logic flow of the representation bidding price determination by the center system 3 and the determination of the highest bidding price in the current cycle in the “bidding period P1.”

The highest bidding price buyers enter after the auction starts (hereafter called the real-time highest bidding price) will already be determined before this flow starts. Therefore, if no buyer participate after the auction starts, the maximum representation bidding price is the representation bidding price.

Step S302:

Judges if the real-time highest bidding price is smaller than “the maximum representation bidding price.” If smaller, it goes to Step S304, if larger or equal, it goes to Step S306.

Step S304:

Adds the minimum bidding price unit (1000 yen in FIG. 7) to the real-time highest bidding price. That price will be the bidding price of “representation” buyers in the current cycle. Then it progresses to Step S310.

Step S306:

Judge if the real-time highest bidding price is equal to the “maximum representation bidding price.” If yes, it goes to Step S308 and set “maximum representation bidding price” as the bidding price of “representation” buyers in the current cycle, then goes to Step S310. If not equal (i.e. larger) it goes to Step S310.

Step S310:

If there are any more “representation bidding” users, it repeats from Step S302, and calculates his (her) bidding price. After the calculation of all the “representation bidding” users, it goes to Step S312.”

Step S312:

Determines the highest bidding price of all “representation bidding” users.

Then, the representation bidding price determination by the center system 3 and the determination of the highest bidding price in the current cycle are completed.

After the process above, the center system 3 uses representation bidding prices and the highest bidding prices determined in “the bidding period P1” to process in the bidding status notification period P2, the trade judgment period P3, and the dealing result notification period P4. Other conditions and processes are the same as described above.

<<Other implementation “reserve price modification”>>

In the description above, an assessor or a seller registers “reserve price” at the assessor equipment 16 before auction session starts. This implementation is an auction system 2 that enables assessors and sellers to enter the second “reserve price” in “The trade judgment period P3” in a certain cycle. Assessors and sellers can decide to sell at the price that is more than the bid price that the bidding status indicates (even though it is less than the reserve price set in advance) by referring to the bidding status of the center system 3, which shows in the “bidding status notification period P2.”

Assessors and sellers can enter the second reserve price (reserve price modification) on the input area 40 on FIG. 5 at the assessor equipment 16 in “trade judgment period P3.” For instance, on the FIG. 6 (2) Assessors and sellers can click the “reserve price modification button” 52 and execute the reserve price modification.

For example, assessors and sellers can execute reserve price modification as follows:

1) Assessors and sellers can modify the reserve price when there is a difference between the highest bidding price and the reserve price set before the auction which is smaller than the “maximum price gap for the reserve price modification” that the organizer can set before the auction. For instance,

In the condition below, specify when assessors and sellers can modify the reserve price.

Reserve price—200,000 yen

Highest bidding price—170,000 yen

Maximum price gap for the reserve price modification—40,000 yen

In the case below, the reserve price modification is not acceptable.

Reserve price—200,000 yen

Highest bidding price—155,000 yen

Maximum price gap for the reserve price modification—40,000 yen

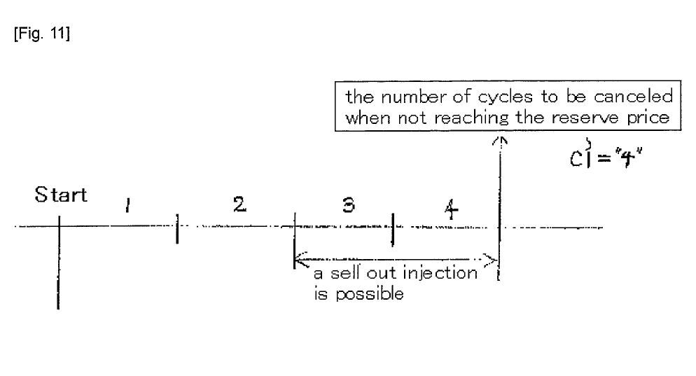

2) An organizer can define the “reserve price modification enabled cycles at the organizer equipment 12 in addition to the “maximum number of cycles.” For instance (refer to FIG. 11),

“Maximum number of cycles” is the number of cycles in which the auction is aborted, when there is no bid higher than the reserve price; this is defined as C1,

“Reserve price modification enabled cycles”—“2,”

Assessors and sellers can modify the reserve price in the cycle “C1-1” and “C1” when there is a bid. That means they can modify in the last two cycles.

3) An assessor can be allowed to modify the reserve price on the assessor equipment 16.

When the reserve price is modified, the goods are sold at the bidding price that the reserve price modification specified. Then the current session and cycle are closed. The center system 3 closes the session without passing through the following processes in the “dealing result notification period P4”

Whether the goods are successfully bid on or not.

Whether the auction continues (and goes onto the next cycle).

### BENEFIT OF THE INVENTION

In these circumstances, the invention realizes the Internet-based real-time auction. Buyers, assessors, and sellers can deal in auctions as they do in traditional auctions since they can continue the auction until there is only one bidder left.

More goods can be traded in shorter period because a session for one good can take several seconds to several minutes. Furthermore, participants can deal at more than one lane at the same time, since the center system can process multiple lanes.

In this auction system, dealings are more controllable for assessors and sellers. This means that they can sell goods at preferable prices.

### ABOUT FIGURES

[FIG. 1] The system structure of the Internet auction system in this invention

[FIG. 2] The work flow chart of the Internet auction system in this invention

[FIG. 3] The symbolized low chart of the Internet auction system in this invention

[FIG. 4] The flow chart that shows the cycles in details

[FIG. 5] Examples of screens on the organizer equipment, the assessor equipment, and buyer equipment in the “bidding entry term P1”

[FIG. 6] An example of an input field on a screen

[FIG. 7] A figure that shows the changes in the bidding time indicator and bidding price indicator

[FIG. 8] The flow chart of the process to determine cycle winners

[FIG. 9] The flow chart of an example of judgments the center system makes in the dealing result notification period P4.

[FIG. 10] The flow chart of logic examples of representation bidding price determination by the center system 3 and the determination of the highest bidding price in the current cycle in the “bidding period P1.”

[FIG. 11] This figure explains the idea of “reserve price modification enabled cycles.”

### SYMBOLS

2 . . . The Internet auction system

3 . . . Center system

4 . . . Auction center

6 . . . Auction center equipment

8 . . . The Internet network

10 . . . Organizer office

| | |
|---|---|
| 1 | 12 . . . Organizer equipment |
| 2 | 14 . . . Independent communication line |
| 3 | 16 . . . Assessor equipment |
| 4 | 18 . . . Assessors |
| 5 | 20 . . . Buyer equipment |
| 6 | 22 . . . Buyers |
| 7 | 24 . . . Lane |
| 8 | 26 . . . Corner |
| 9 | 28 . . . Session |
| 10 | 30 . . . Cycle |
| 11 | 32 . . . Screen |
| 12 | 34 . . . Photograph field |
| 13 | 36 . . . Information field 1 |
| 14 | 38 . . . Information field 2 |
| 15 | 40 . . . Input area |
| 16 | 42 . . . Time indicator |
| 17 | 44 . . . Bidding price indicator |
| 18 | 46 . . . Buyer's bid button |
| 19 | 48 . . . Starting price display field |
| 20 | 50 . . . Status chart |
| 21 | 52 . . . Reserve price modification button |
| 22 | 54 . . . Continue button |

[Document Name] Summary

### SUMMARY

[Subject] Realizing real-time auction system that is the same as traditional auctions by utilizing the Internet.

### SOLUTION

(1) The buyer bids (a price). The bid information is transmitted from the buyers' computer. (2) The bidding status is transmitted to each computer. (3) The organizer, the assessor and the buyer confirm the bidding status. (4) If there is more than one bid above the reserve price set by the assessor, the process repeats from (1). The process repeats until there is only one bid left. Then the bidder that remains is the successful bidder. Even though there is no bid above the price proposed by the assessor, the process repeats from step 1. However, it does not repeat more than the prescribed number of times.

[Reference Figure] FIG. 6

What is claimed is:

1. A real-time auction system comprising:
a first computer operated by an auction organizer;
a second computer operated by an assessor who exhibits and sells products;
a plurality of third computers operated by buyers;
a fourth computer in a center for processing;
all of the computers being connected to an online system for receiving and sending data on an auction;
the auction being performed as follows:
step 1: the buyers bid a price for a product during a first predetermined time period, with the bid price being transmitted to the first computer;
step 2: status of bidding on the product is transmitted to all of the computers over the online system;
step 3: the organizer, the assessor and the buyers confirming the bidding status during a second predetermined time period;
step 4: if there is more than one bid above a reserve price for the product set by the assessor, step 1, step 2 and step 3 are repeated a predetermined number of times until there is only one bid left; the one bid left being the successful bidder;

2. The real-time auction system of claim 1 wherein screens of the third computers have a time indicator, a bid price indicator and a bid button; and wherein during the first predetermined time period a gradually increasing price is displayed on the bid price indicator from a start price to a ceiling price while the time indicator rises at the same time and at the same speed.

3. The real-time auction system of claim 2 wherein the buyers may click on the bid button when the bid price indicator reaches a price the buyers want to bid.

4. The real-time auction system of claim 3 wherein the buyers may enter a pre-entered bid before the auction opens; the pre-entered bid being entered by the buyers when the auction is open and being treated as maximum bid prices.

5. The real-time auction system of claim 4 wherein if no bid is above the reserve price for the product set by the assessor, the assessor can designate the buyer who bid the highest price as the successful bidder on the second computer.

6. The real-time auction system of claim 5 wherein a first bidder who enters a price that is above the reserve price for the product set by the assessor can see an indication that the first bidder was the first to enter such a price.

7. The real-time auction system of claim 6, further including electromagnetic media for storing computer programs used by the first computer, the second computer, the plurality of third computers and the fourth computer.

8. The real-time auction system of claim 1 wherein the buyers may enter a pre-entered bid before the auction opens; the pre-entered bid being entered by the buyers when the auction is open and being treated as a maximum bid price.

9. The real-time auction system of claim 2 wherein the buyers may enter a pre-entered bid before the auction opens; the pre-entered bid being entered by the buyers when the auction is open and being treated as a maximum bid price.

10. The real-time auction system of claim 1 wherein if no bid is above the reserve price for the product set by the assessor, the assessor can designate the buyer who bid the highest price as the successful bidder on the second computer.

11. The real-time auction system of claim 2 wherein if no bid is above the reserve price for the product set by the assessor, the assessor can designate the buyer who bid the highest price as the successful bidder on the second computer.

12. The real-time auction system of claim 3 wherein if no bid is above the reserve price for the product set by the assessor, the assessor can designate the buyer who bid the highest price as the successful bidder on the second computer.

13. The real-time auction system of claim 4 wherein if no bid is above the reserve price for the product set by the assessor, the assessor can designate the buyer who bid the highest price as the successful bidder on the second computer.

14. The real-time auction system of claim 1 wherein a first bidder who enters a price that is above the reserve price for the product set by the assessor can see an indication that the first bidder was the first to enter such a price.

15. The real-time auction system of claim 2 wherein a first bidder who enters a price that is above the reserve price for the product set by the assessor can see an indication that the first bidder was the first to enter such a price.

16. The real-time auction system of claim 3 wherein a first bidder who enters a price that is above the reserve price for the product set by the assessor can see an indication that the first bidder was the first to enter such a price.

17. The real-time auction system of claim 4 wherein a first bidder who enters a price that is above the reserve price for the product set by the assessor can see an indication that the first bidder was the first to enter such a price.

18. The real-time auction system of claim 5 wherein a first bidder who enters a price that is above the reserve price for the product set by the assessor can see an indication that the first bidder was the first to enter such a price.

19. The real-time auction system of claim 1, further including electromagnetic media for storing computer programs used by the first computer, the second computer, the plurality of third computers and the fourth computer.

20. The real-time auction system of claim 2, further including electromagnetic media for storing computer programs used by the first computer, the second computer, the plurality of third computers and the fourth computer.
